(19) United States
(12) Patent Application Publication
(10) Pub. No.: US 2023/0029089 A1
(43) Pub. Date: Jan. 26, 2023

(54) ASSEMBLY FOR MOUNTING TILES OVER A SURFACE

(71) Applicant: Arka Energy Inc., Union City, CA (US)

(72) Inventor: Chethana GOPALAGOWDA, Bangalore (IN)

(21) Appl. No.: 17/838,538

(22) Filed: Jun. 13, 2022

(30) Foreign Application Priority Data
Jun. 12, 2021 (IN) 202111026249

(51) Int. Cl. E04D 1/34; E04D 1/00; H02S 30/10

(52) U.S. Cl. CPC E04D 1/34; E04D 1/2918; H02S 30/10; E04D 2001/3473; E04D 2001/3488

(57) ABSTRACT

Present disclosure relates to an assembly for mounting solar panel tiles or other tiles/panels over a roof (surface). Assembly includes C-shaped base frames provided with holes at the bottom for fixing them parallelly over the roof. Rows of tiles are then mounted over two adjacent base frames. Assembly further includes Z-shaped clamping frames for holding the tile which sits and is mounted on the base frames. Clamping frames hold the tile at the top, and the bottom of another tile resting on a previous clamping frame. An area close to the bottom edge of tiles has a layer of adhesive that helps in attaching the bottom edge of tile to the top of a previous clamping frame, thereby making the assembly aesthetically pleasing and leakproof. Another set of holes are provided on the base frames, and clamping frames, to allow cables to pass through them, and provide proper ventilation beneath the assembly.

### TECHNICAL FIELD

The present disclosure relates to the field of solar panel mounting systems. More particularly, the present disclosure relates to a simple, efficient, and aesthetically pleasing assembly for mounting solar panel tiles or other tiles over a roof or other surfaces, which has waterproofing capability, provides suitable ventilation beneath the solar panels, allows easier and hidden attachment of corresponding cables and power conversion devices, prevents fire, and is easy to be installed, repaired, and replaced.

### BACKGROUND

With the increase in pollution and limited non-renewable sources available, the world is switching towards renewable sources of energy. Solar power is one such renewable energy that is easily available everywhere. However, due to the amount of area required for installing solar panels and the high cost of land, people are now installing solar panels on their private building structures.

Solar panels or photovoltaic (PV) modules have been deployed in a wide variety of ways, including deployment on the roofs, sheds, and balconies of buildings, including private homes, commercial structures, and offices. However, such panels have not been capable of being readily integrated into roof structures constructed of standard roofing materials, placing a limitation on the usage of solar panels in a variety of locations where solar energy could otherwise be collected.

The existing system of installing solar panels on residential rooftops involves using elevated steel structures or sections that show the solar panel system as a separate entity and not a part of the roof Besides, the module size, shape, and color of the solar panels do not match with that of the roof and this leads to poor aesthetics. In addition, the existing system is not leakproof and they fail to protect the roof beneath the solar panels from wind, rain, snow, dust, and other external conditions.

In addition, since the roof remains covered by the solar panels, the temperature beneath the solar panels also rises significantly, thereby affecting the performance of solar panels and corresponding cables, and devices, and also increase the temperature inside the buildings. In severe heat conditions, the increased temperature beneath the solar panels might also completely damage the solar panel system. Also, the existing system does not have a fire-resistant capability, which makes it vulnerable to increased heat conditions or fire. In the worst case, any starting of a fire in the solar panels or the existing system may also lead to a fire breakout over the roof as well as inside the corresponding building.

Further, in the existing system, the corresponding cables and devices of the solar panels remain outside and exposed to the external environment, which may significantly damage them. Also, the existing system is difficult to be installed, repaired, and replaced due to the involvement of a large number of components, which consumes time and requires skilled personnel for installation and repairing.

Therefore, there is a need in the art to develop a simple yet efficient assembly for mounting solar panel tiles or other tiles over a roof or other surfaces, which has waterproofing capability, increases the performance of the solar panels by providing suitable ventilation, allows easier and hidden attachment of corresponding cables and power conversion devices, prevents fire, is easy to install, repair, and replace, and fulfills the aesthetics that the consumers expect.

### OBJECTS OF THE PRESENT DISCLOSURE

Some of the objects of the present disclosure, which at least one embodiment herein satisfies are as listed herein below.

It is an object of the present disclosure to provide a simple and efficient assembly for mounting solar panel tiles or other tiles over a roof or other surfaces. Solar panel tiles herein are also referred to as solar tiles, which are frameless solar panels.

It is an object of the present disclosure to provide an aesthetically pleasing assembly for mounting solar panel tiles or other tiles over a roof or other surfaces, which shows the solar panels as a part of the roof and not as a separate add on entity, and fulfills the aesthetics that the consumers expect

It is an object of the present disclosure to provide an assembly for mounting solar panel tiles or other tiles over a roof or other surfaces, which is easy and affordable to be installed, repaired, and replaced, without the involvement of skilled personnel.

It is an object of the present disclosure to provide a simple, efficient, and aesthetically pleasing assembly for mounting solar panel tiles or other tiles over a roof or other surfaces, which provides proper ventilation beneath the assembly to facilitate convection cooling at rear side or beneath the tiles.

It is an object of the present disclosure to provide a fireproof assembly for mounting solar panel tiles or other tiles over a roof or other surfaces.

It is an object of the present disclosure to provide an assembly for mounting solar panel tiles or other tiles over a roof or other surfaces, which is structurally stable, and less prone to structural failure due to uplift forces.

It is an object of the present disclosure to provide an assembly for mounting solar panel tiles or other tiles over a roof or other surfaces, which has waterproofing capability and also protects the assembly and roof from external weather conditions.

### SUMMARY

The present disclosure relates to a simple, efficient, and aesthetically pleasing assembly for mounting solar panel tiles or other tiles over a roof or other surfaces, which has waterproofing capability, provides suitable ventilation beneath the solar panels, allows easier and hidden attachment of corresponding cables and power conversion devices, prevents fire, and is easy to be installed, repaired, and replaced.

According to an aspect of the present disclosure, the assembly may comprise C-shaped base frames, which may be adapted to be removably configured over a surface of an area of interest (AOI) such that two adjacent base frames are extending parallelly and spaced apart by a predefined distance therebetween based on a dimension of tiles to be mounted thereon. The AOI may be a roof or a surface, and the tiles may be solar panel tiles, glass panels, or other aesthetic panels.

Further, rows of the tiles may be mounted over the two adjacent base frames such that one side of the tiles is positioned over one of the base frames and another opposite side of the corresponding tiles is positioned over the other adjacent base frame. Further, the assembly may comprise Z-shaped clamping frames adapted to be removably configured over the surface, and the C-shaped base frames. One of the clamping frames may be configured with each of the base frames such that at least one side of the row of one or more tiles is clamped between one of the base frames and a corresponding clamping frame, thereby enabling mounting of the tiles over the assembly. Besides, the use of a minimal number of easily available and affordable components in the assembly, makes it easy and affordable to be installed, repaired, and replaced, without involvement of skilled personnel.

In an aspect, the C-shaped base frames may comprise a first middle section, and a first upper section, and a first lower section extending perpendicularly from two opposite ends of the first middle section in the same direction to form the C-shaped structure. Further, Z-shaped clamping frames may comprise a second middle section, and a second upper section, and a second lower section extending perpendicularly from two opposite ends of the fourth middle section in opposite directions to form the Z-shaped structure. Furthermore an rubber gasket can be added along the top edge of the tile to help in clamping as well as avoiding direct contact between the metal and the tile. The bottom edge of the tile may be attached to Z section using any suitable method (example using structural adhesive, but not limited to the like).

One side of the row of tiles may be clamped between the first upper section, and the second upper section of a corresponding base frame, and clamping frames, respectively. Further, the other side of the row of tiles may be configured over the second upper section of the adjacent clamping frame. Further, two adjacent rows of the tiles may be configured in the assembly such that one side of the tiles of one of the adjacent rows overlaps one side of the tiles associated with another adjacent row of tiles. This makes the assembly aesthetically pleasing, which shows the solar panels as a part of the roof and not as a separate add on entity, and fulfills the aesthetics that the consumers expect

In an aspect, the assembly may comprise any or a combination of a plate, and rubber being configured at the one side of each of the one or more tiles using any suitable method known in the art, such that the two adjacent rows of the one or more tiles overlapping each other forms a leak-proof assembly. This provides the assembly with leak proofing capability, thereby protecting the assembly as well as the roof from external weather conditions such as rain, snow, dust, and other conditions.

In an aspect, the C-shaped base frames may comprise a plurality of first holes at the bottom, which facilitates coupling of the base frames over the surface of the AOI. Further, the Z-shaped clamping frames may comprise a plurality of second holes at the bottom and in line with the plurality of first holes of the corresponding base frame, to facilitate coupling of the clamping frames over the surface of the AOI, and the corresponding base frame.

In an aspect, the assembly may comprise one or more fixtures selected from any or a combination of bolt, screw, and clamps, which may be adapted to pass through the first holes and the second holes of the base frame and clamping frames, to enable coupling of the base frames over the surface, and coupling of the clamping frames on the corresponding base frames.

In another aspect, the base frames may comprise a plurality of third holes, and the clamping frames may comprise a plurality of fourth holes. The third holes and the fourth holes of the base frame and clamping frames may allow air to flow therethrough to keep the bottom of the tiles cool. This provides proper ventilation beneath the assembly, thereby facilitating convection cooling at the rear side or beneath the tiles. Further, the third holes and fourth holes of the base frame and clamping frames may also allow cables to pass therethrough to keep the cables hidden beneath the assembly, and making the assembly aesthetically pleasing.

In an aspect, the C-shaped base frames, and the Z-shaped clamping frames may be made of a material selected from metals, fire-retardant plastics, and fire-retardant materials. Further, a fire-resistant underlayment and a gypsum board may be configured over the surface of the AOI, and the assembly may be configured there over to improve the fire resistance capability of the assembly.

Various objects, features, aspects and advantages of the present disclosure will become more apparent from the following detailed description of preferred embodiments, along with the accompanying drawing figures in which like numerals represent like features.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

FIG. 1A illustrates an exemplary of the proposed assembly having the C-shaped base frames being parallelly configured over a surface, in accordance with an embodiment of the present disclosure.

FIGS. 1B-1C and 1E-1F illustrate exemplary views of the assembly of FIG. 1A having a single tile over it, in accordance with an embodiment of the present disclosure.

FIGS. 1D and 1G-1H illustrate exemplary views of the assembly of FIG. 1A having multiple rows of tiles being configured over the proposed assembly.

FIG. 2 illustrates an exemplary view of the C-shaped base frame of the proposed assembly in accordance with an embodiment of the present disclosure.

FIG. 3 illustrates an exemplary view of the Z-shaped clamping frame of the proposed assembly in accordance with an embodiment of the present disclosure.

FIGS. 4A-4C illustrates exemplary views of the tiles of the proposed assembly in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

The present disclosure relates to the field of solar panel mounting systems. More particularly, the present disclosure relates to a simple, efficient, and aesthetically pleasing assembly for mounting solar panel tiles or other tiles over a roof or other surfaces, which has waterproofing capability, provides suitable ventilation beneath the solar panels, allows easier and hidden attachment of corresponding cables and power conversion devices, prevents fire, and is easy to be installed, repaired, and replaced.

According to an aspect, the present disclosure elaborates upon an assembly for mounting tiles or solar panel tiles over a surface or roof The assembly can include at least two C-shaped base frames, which can be adapted to be removably configured over a surface of an area of interest (AOI) such that two adjacent base frames among the at least two base frames are extending parallelly and spaced apart by a predefined distance therebetween based on a dimension of one or more tiles to be mounted thereon. A row of one or more tiles can be mounted over the two adjacent base frames such that one side of the corresponding tiles is positioned over one of the base frames and another opposite side of the corresponding tiles is positioned over the other adjacent base frame. Further, the assembly can include at least two Z-shaped clamping frames adapted to be removably configured over any or a combination of the surface, and the at least two base frames. One of the clamping frames can be configured with each of the at least two base frames such that at least one side of the row of one or more tiles is clamped between one of the base frames and a corresponding clamping frame.

In an embodiment, one or more tiles can be selected from any or a combination of solar panel tiles, glass panels, roof panels, and aesthetic panels. Further, the AOI can be selected from a roof of a building, balcony of a building, sheds, park, and land.

In an embodiment, each of the at least two base frames can include a first middle section, and a first upper section, and a first lower section extending perpendicularly from two opposite ends of the first middle section in the same direction to form the C-shaped structure. Further, each of the at least two clamping frames can include a second middle section, and a second upper section, and a second lower section extending perpendicularly from two opposite ends of the fourth middle section in opposite directions to form the Z-shaped structure. Further, an area close to a bottom edge of the tile can be attached to a top of the previous clamping frame using a suitable method to provide structural support and water proofing.

In an embodiment, the one side of the row of one or more tiles can be clamped between the first upper section, and the second upper section of a corresponding base frame, and clamping frames, respectively. Further, the other side of the row of one or more tiles can be configured over the second upper section of the adjacent clamping frame.

In an embodiment, two adjacent rows of the one or more tiles can be configured in the assembly such that one side of the one or more tiles associated with one of the adjacent rows overlaps one side of the one or more tiles associated with another adjacent row of the one or more tiles.

In an embodiment, the assembly can include any or a combination of a plate, and rubber being configured at the one side of each of the one or more tiles using an suitable method, such that the two adjacent rows of the one or more tiles overlapping each other forms a leak-proof assembly.

In an embodiment, the first lower section of each of the at least two base frames can include a plurality of first holes, which facilitates coupling of the at least two base frames over the surface of the AOI. Further, the second lower section of each of the at least two clamping frames can include a plurality of second holes in line with the plurality of first holes of the corresponding base frame, to facilitate coupling of the at least two clamping frames over the surface of the AOI, and the corresponding base frame.

In an embodiment, the assembly can include one or more fixtures selected from any or a combination of a bolt, screw, and clamps, which can be adapted to pass through any or a combination of the plurality of first holes and the plurality of second holes, to enable coupling of the at least two base frames over the surface, and coupling of the at least two clamping frames on the corresponding base frames.

In an embodiment, the first middle section of each of the at least two base frames can include a plurality of third holes, and the second middle section of each of the at least two clamping frames can include a plurality of fourth holes, where the plurality of third holes and the plurality of fourth holes can allow air to flow therethrough to keep bottom of the one or more tiles cool, and further allowing one or more cables to pass therethrough to keep the one or more cables beneath the one or more tiles.

In an embodiment, at least two base frames, and the at least two clamping frames can be made of a material selected from metals, fire-retardant plastics, and fire-retardant materials. Further, a fire-resistant underlayment and a gypsum board can be configured over the surface of the AOI, and the assembly can be configured there over to improve the fire resistance capability of the assembly.

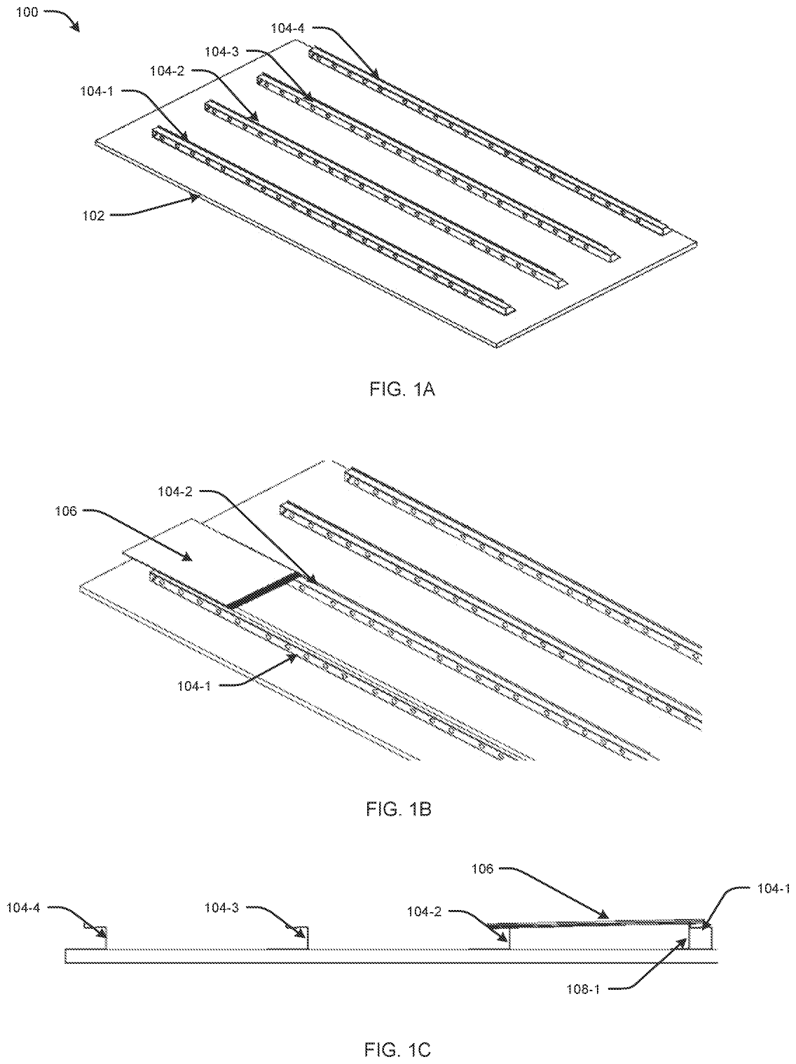

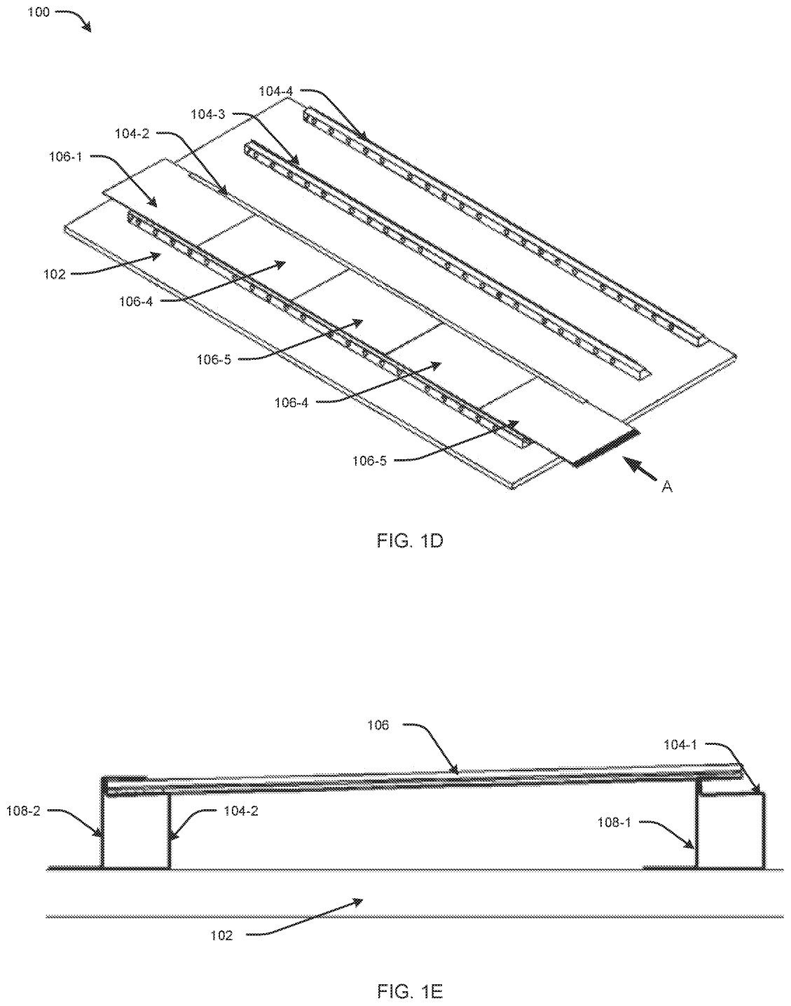

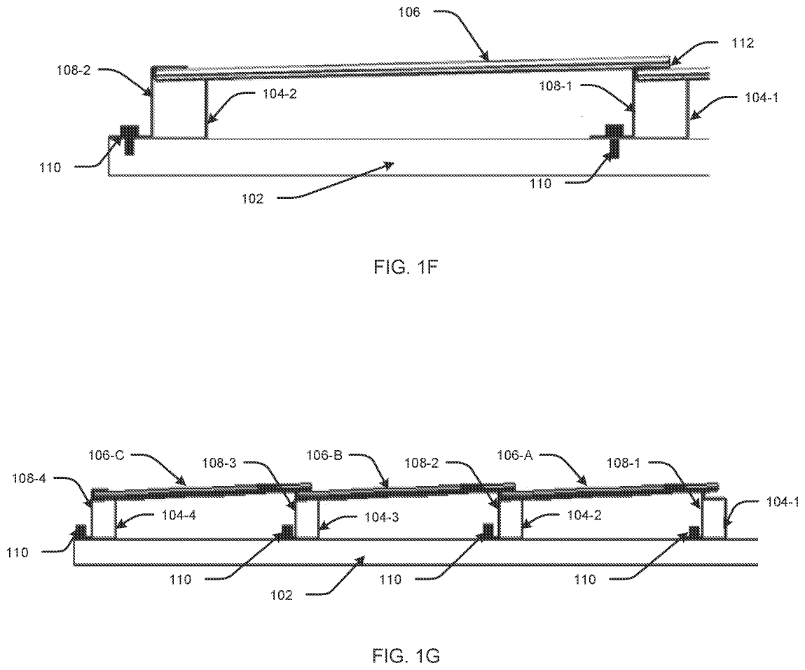

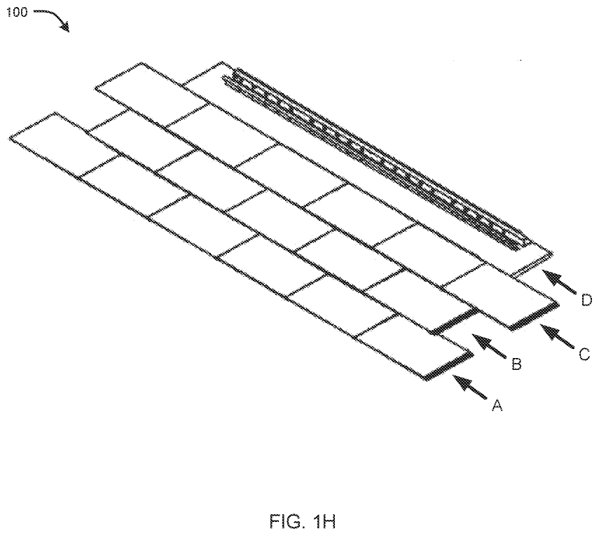

Referring to FIGS. 1A to 1H, the proposed assembly 100 can include at least two C-shaped base frames 104-1 to 104-4 (collectively referred to as base frames 104, herein), each adapted to be removably configured over a surface 102 of an area of interest (AOI) such that two adjacent base frames (104-1, 104-2) or (104-2, 104-3) or (104-3, 104-4) are extending parallelly and spaced apart by a predefined distance therebetween based on a dimension of one or more tiles 106-1 to 106-5 (collectively referred to as tiles 106, or individually referred to as tile 106, herein) to be mounted thereon as shown in FIG. 1A-1B. Further, as illustrated in FIGS. 1C, 1E-1G, the tiles 106 can be mounted over the two adjacent base frames (104-1, 104-2) or (104-2, 104-3) or (104-3, 104-4) one by one such that one side of the corresponding tiles 106 is positioned over one of the base frame 104-1 and another opposite side of the corresponding tiles are positioned over the other adjacent base frame 104-2. Further, the assembly 100 can include at least two Z-shaped clamping frames 108-1 to 108-4 (collectively referred to as clamping frames 108, herein), adapted to be removably configured over any or a combination of the surface 102, and the base frames 104. One of the clamping frames 108 can be configured with one of the base frames 104 such that at least one side of the row of the tiles 106 can be clamped between one of the base frames 104 and a corresponding clamping frame 108.

Accordingly, upon mounting and clamping of a set of tiles 106-1 to 106-5, one by one, between two adjacent base frames (say 104-1 and 104-2) and corresponding clamping frames (108-1 and 108-2), a row of tiles (A) can be successfully mounted as shown in FIGS. 1D-1F. Further, another set of tiles 106 can be mounted over another two adjacent base frames, one by one, which can be clamped by the corresponding clamping frames, to mount another row of tiles (B to D) adjacent to a previous row of tiles A, as shown in FIG. 1G-1H. This makes the assembly 100 aesthetically pleasing, which shows the solar panels or tiles 106 as a part of the roof and not as a separate add on entity, and fulfills the aesthetics that the consumers expect. Besides, the use of a minimal number of easily available and affordable components in the assembly 100, makes it easy and affordable to be installed, repaired, and replaced, without the involvement of skilled personnel

In an embodiment, two adjacent rows of the tiles (A to D) can be configured in the assembly 100 such that one side of the tiles 106-A associated with one of the adjacent rows (say A) overlaps one side of the tiles 106-B associated with another adjacent row of the tiles (B). Further, the assembly 100 can include any or a combination of a plate, and rubber being configured at the one side or edge of each of tiles 106 using an adhesive 112, such that the edges of two adjacent rows (A to B) of the tiles overlapping each other forms a leak-proof assembly 100. The plate or rubber can be attached at one end of the bottom of the tile that overlaps with an adjacent tile. Further, an area close to the bottom edge of tiles 106 can have a layer of high bonding adhesive/adhesive tapes 112 that helps in attaching the bottom edge of the tile 106 to the top of a previous clamping frame 108 to form a leak-proof assembly.

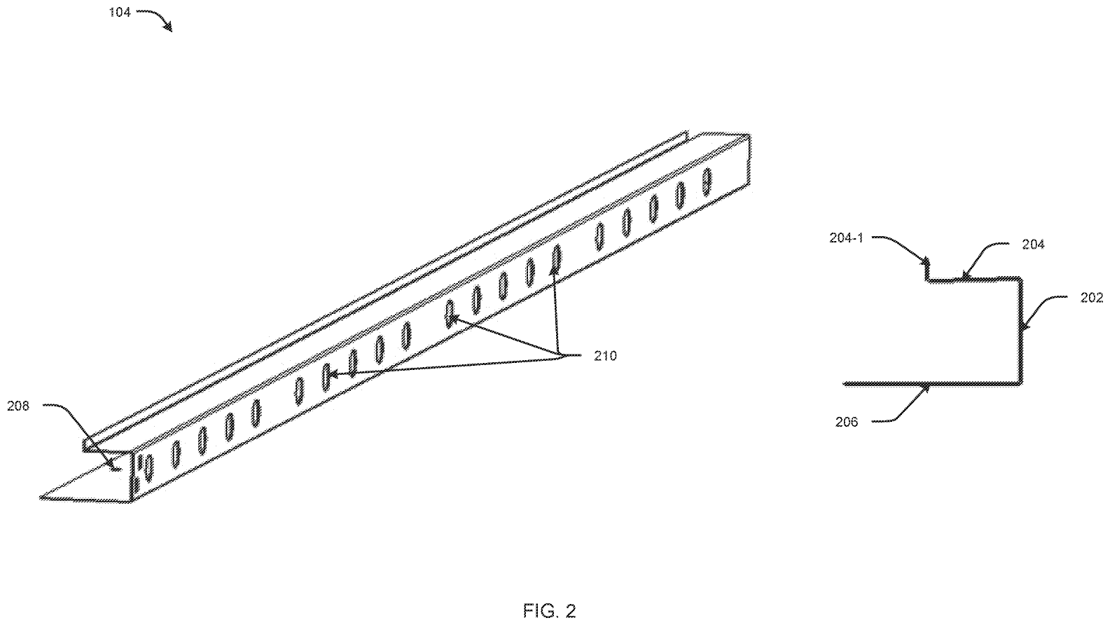

Referring to FIG. 2, in an embodiment, each C-shaped base frame 104 can include a first middle section 202, and a first upper section 204, and a first lower section 206 extending perpendicularly from two opposite ends of the first middle section 202 in the same direction to form the C-shaped structure 104. The base frame 104 can be oriented such that the first lower section 206 remains at the bottom and parallelly touching the surface 102. Further, the first upper section 204 can have a protrusion 204-1 extending perpendicularly from an end to facilitate holding of the tiles 106 over the base frame 103. One side of the tile 106 can be mounted and held on the first upper section 204 and the protrusion 204-1 of the base frame 104.

In an embodiment, the first lower section 206 of each base frame 104 can include a plurality of first holes 208, which facilitates coupling of the base frames 104 over the surface 102 of the AOI using one or more fixtures 110. Further, the first middle section 202 of each base frame 104 can include a plurality of third holes 210.

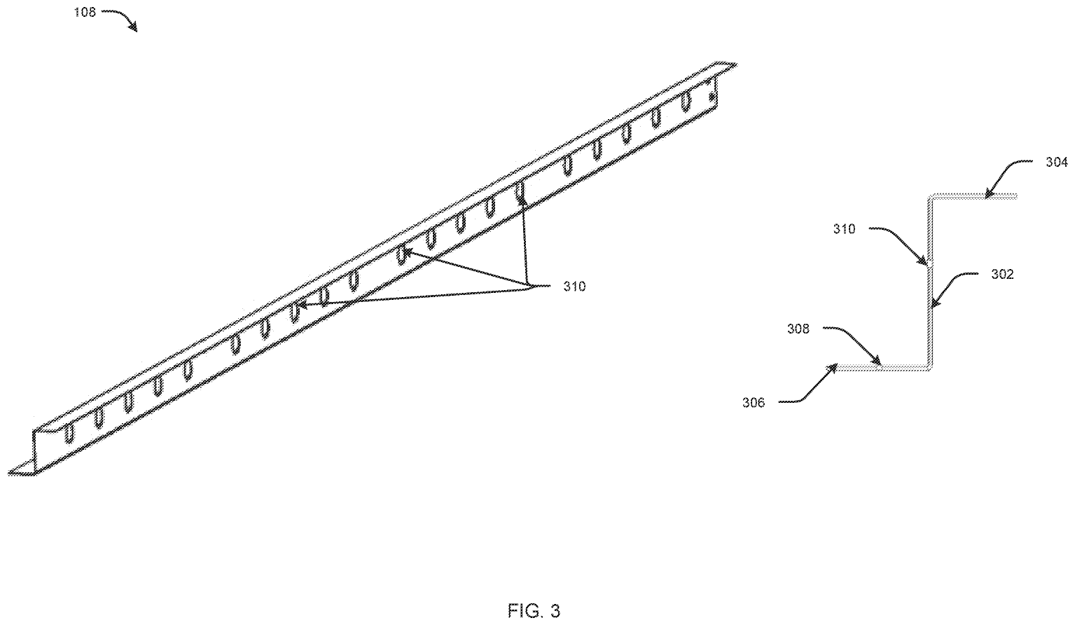

Referring to FIG. 3, in an embodiment, each Z-shaped clamping frame 108 can include a second middle section 302, and a second upper section 304, and a second lower section 306 extending perpendicularly from two opposite ends of the fourth middle section in opposite directions to form the Z-shaped structure 108. In an implementation, another side of the mounted tile 106 (whose one side is mounted on the first upper section 204 and the protrusion 204-1 of the base frame 104) can be configured over the second upper section 304 of the adjacent clamping frame 108.

In an embodiment, the second lower section 306 of each clamping frame 108 can include a plurality of second holes 308, which facilitates coupling of the clamping frames 108 over the surface 102 and the first lower section 206 of the base frame 104 using the one or more fixtures 110. Further, the second middle section 302 of each clamping frame 108 can include a plurality of fourth holes 310.

In an embodiment, the clamping frame 108 can be oriented and positioned over the C-shaped base frame 104 such that the second lower section 306 remains at the bottom and parallelly touching the first lower section 206 of a corresponding base frame 104 so that the first holes 208 of base frame 104 and the second holes 308 of the clamping frame 108 remains in line with each other, and the third holes 210 of the base frame 104 and the fourth holes 310 of the clamping frame 108 remains in line with each other. Further, the second upper section 204 of the clamping frame 108 sits over the protrusion 204-1 of the base frame 1-4 or a tile 106 being mounted over the first upper section 204 of the base frame 104.

In an embodiment, the assembly 100 can include the one or more fixtures 110 selected from any or a combination of a bolt, screw, and clamps, which are adapted to pass through any or a combination of the plurality of first holes 208 of the base frame 104, and the plurality of second holes 308 of the clamping frame 108 being configured over the base frame 104, to enable coupling of the base frames 104 over the surface 104, and coupling of the clamping frames 108 on the corresponding base frames 104.

In an embodiment, the plurality of third holes 210 of the base frame 104 and the plurality of fourth holes 310 of the clamping frame 108 can allow air to flow therethrough to provide proper ventilation and keep the bottom of the tiles 106 cool by convection cooling. Further, in another embodiment, the plurality of third holes 210 of the base frame 104 and the plurality of fourth holes 310 of the clamping frame 108 can allow one or more cables associated with the solar tiles to pass therethrough to keep the cables hidden beneath the tiles 106 or assembly 100.

In an embodiment, the base frames 104, and the clamping frames 108 can be made of a material selected from metals, fire-retardant plastics, fire-retardant materials, but not limited to the likes. Further, a fire-resistant underlayment and/or a gypsum board or deck can be configured over the surface 102 of the AOI or the roof 102, and the assembly 100 can be configured thereover to improve the fire resistance capability of the assembly 100.

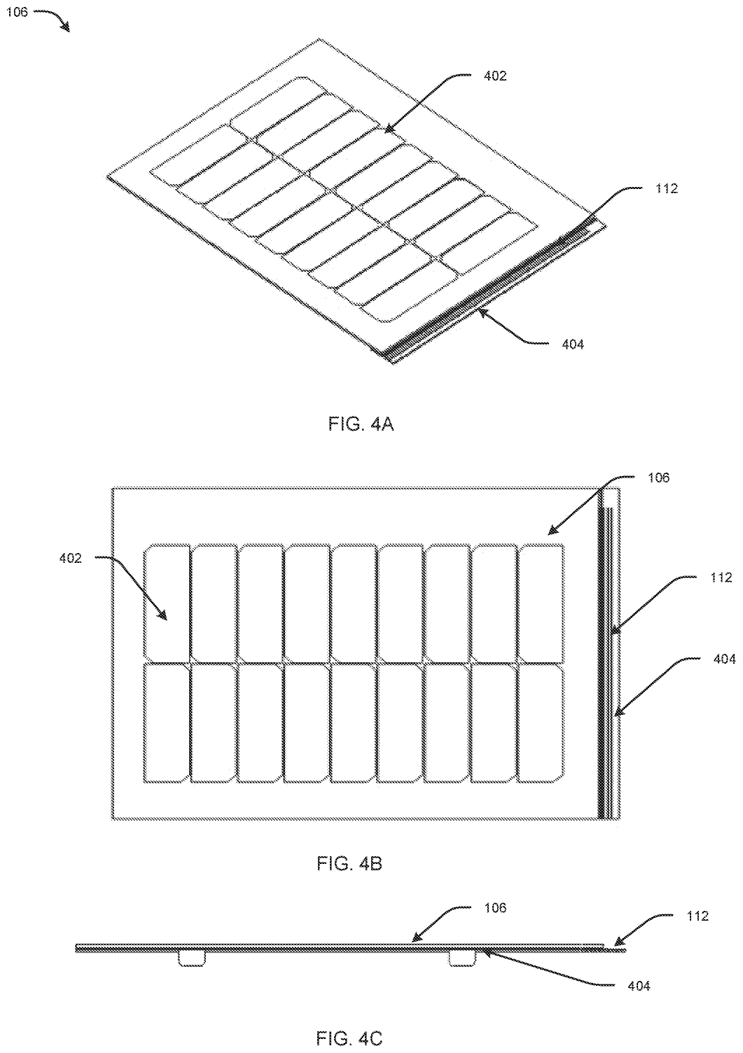

Referring to FIGS. 4A-4C, in an embodiment, tile 106 can be a solar panel tile having multiple photovoltaic modules 402 being configured over a surface of the tile 106. Further, a plate, and/or rubber 404 can be configured at one side or edge of each tiles 106 using an adhesive 112, such that the edges of two adjacent rows of the solar panel tiles 106 overlaps each other forms a leak-proof assembly. The plate or rubber 404 can be attached at one end of the bottom of the solar panel tile 106-1 that overlaps with an adjacent solar panel tile 106-2. In an exemplary embodiment, an area close to the bottom edge of solar panel tiles 108 can have a layer of high bonding adhesive/adhesive tapes 112 that helps in attaching the bottom edge of the solar panel tile 106 to the top of a previous clamping frame 108 to form a leak-proof assembly 100, thereby protecting the assembly as well as the roof from external weather conditions such as rain, snow, dust, and other conditions.

In an implementation, at least two C-shaped base frames 106-1 to 106-4 can be parallelly attached to the roof or surface 102 using the fixtures 110 passing through the first holes as shown in FIG. 1A. Further, tiles 106 can be one by one mounted on the C-shaped base frame to form a row of tiles (A) as shown in FIGS. 1B-1D. Further, adjacent tiles 106 can be placed on the corresponding plate or rubber 404 attached to one side of the tile 106 to form a leak proofing, and attaching them with Z-shaped clamping frame 108 as shown in FIGS. 1G-1H, and 4A-4C. As shown in FIG. 1G, the Z-shaped clamping frames 108-2 can hold the tile 106-B at the top, and the bottom of the tile 106-A resting on a previous Z-shaped clamping frame 108-1 that is holding the tile 106-A. The area close to the bottom edge of the tile 106 can have a layer of high bonding adhesive/adhesive tapes 112 that helps in attaching the bottom edge to the top of a previous Z-shaped clamping frame 108-1 as shown in FIGS. 1G and 4A-4C. Finally, once the row (A) of tiles are fixed to the C-shaped base frame 104, they can be locked by the Z-shaped clamping frame 108, and the next row (B to D) of tiles can cover the Z-shaped base frame 108 as shown in FIG, 1G-1H, making the whole assembly aesthetically pleasing, and leak proof.

Those skilled in the art would appreciate that embodiments of the present disclosure utilize various novel and inventive features by providing a simple yet efficient assembly for mounting solar panel tiles or other tiles over a roof or other surfaces, which has waterproofing capability, increases performance of the solar panels by providing suitable ventilation, allows easier and hidden attachment of corresponding cables and power conversion devices, prevents fire, is easy to install, repair, and replace, and fulfills the aesthetics that the consumers expect.

Further, it is to be appreciated by a person skilled in the art that while various embodiments, and drawings of the present disclosure have been elaborated by considering four C-shaped base frame and Z-shaped clamping frame, and five tiles in one row, however, the number of C-shaped base frame, Z-shaped clamping frame, tiles, and roes of tiles, are not just limited to the given number, but can be of any number based on the requirement of user, and all such embodiments are well within the scope of the present disclosure.

While some embodiments of the present disclosure have been illustrated and described, those are completely exemplary in nature. The disclosure is not limited to the embodiments as elaborated herein only and it would be apparent to those skilled in the art that numerous modifications besides those already described are possible without departing from the inventive concepts herein. All such modifications, changes, variations, substitutions, and equivalents are completely within the scope of the present disclosure. The inventive subject matter, therefore, is not to be restricted except in the spirit of the appended claims.

### ADVANTAGES OF THE PRESENT DISCLOSURE

The present disclosure provides a simple and efficient assembly for mounting solar panel tiles or other tiles over a roof or other surfaces.

The present disclosure provides an aesthetically pleasing assembly for mounting solar panel tiles or other tiles over a roof or other surfaces, which shows the solar panels as a part of the roof and not as a separate add on entity, and fulfills the aesthetics that the consumers expect

The present disclosure provides an assembly for mounting solar panel tiles or other tiles over a roof or other surfaces, which is easy and affordable to be installed, repaired, and replaced, without the involvement of skilled personnel.

The present disclosure provides a simple, efficient, and aesthetically pleasing assembly for mounting solar panel tiles or other tiles over a roof or other surfaces, which provides proper ventilation beneath the assembly to facilitate convection cooling at the rear side or beneath the tiles.

The present disclosure provides a fireproof assembly for mounting solar panel tiles or other tiles over a roof or other surfaces.

The present disclosure provides provide an assembly for mounting solar panel tiles or other tiles over a roof or other surfaces, which is structurally stable, and less prone to structural failure due to uplift forces.

The present disclosure provides an assembly for mounting solar panel tiles or other tiles over a roof or other surfaces, which has waterproofing capability, and also protects the assembly and roof from external weather conditions.

1. An assembly for mounting tiles over a surface, the assembly comprising:
at least two C-shaped base frames, each adapted to be removably configured over a surface of an area of interest (AOI) such that two adjacent base frames among the at least two base frames are extending parallelly and spaced apart by a predefined distance therebetween based on a dimension of one or more tiles to be mounted thereon;
wherein a row of the one or more tiles is mounted over the two adjacent base frames such that one side of the corresponding tiles is positioned over one of the base frames and another opposite side of the corresponding tiles is positioned over the other adjacent base frame; and
at least two Z-shaped clamping frames adapted to be removably configured over any or a combination of the surface, and the at least two base frames, wherein one of the clamping frames is configured with each of the at least two base frames such that at least one side of the row of one or more tiles is clamped between one of the base frames and a corresponding clamping frame.

2. The assembly as claimed in claim 1, wherein each of the at least two base frames comprises a first middle section, and a first upper section and a first lower section extending perpendicularly from two opposite ends of the first middle section in same direction to form the C-shaped structure, and
wherein each of the at least two clamping frames comprises a second middle section, and a second upper section and a second lower section extending perpendicularly from two opposite ends of the fourth middle section in opposite directions to form the Z-shaped structure.

3. The assembly as claimed in claim 2, wherein the one side of the row of one or more tiles is clamped between the first upper section, and the second upper section of a corresponding base frame, and clamping frames, respectively, and wherein the other side of the row of one or more tiles is configured over the second upper section of the adjacent clamping frame, and wherein an area close to a bottom edge of the tile is attached to a top of the previous clamping frame using a suitable method to provide structural support and water proofing.

4. The assembly as claimed in claim 3, wherein two adjacent rows of the one or more tiles are configured in the assembly such that one side of the one or more tiles associated with one of the adjacent rows overlaps one side of the one or more tiles associated with another adjacent row of the one or more tiles.

5. The assembly as claimed in claim 4, wherein the assembly comprises any or a combination of a plate, and rubber being configured at the one side of each of the one or more tiles using any suitable method, such that the two adjacent rows of the one or more tiles overlapping each other forms a leak-proof assembly.

6. The assembly as claimed in claim 1, wherein the one or more tiles is selected from any or a combination of solar panel tile, glass panel, and roof panel, aesthetic panels, and wherein the AOI is selected from a roof of a building, balcony of a building, park, and land.

7. The assembly as claimed in claim 2, wherein the first lower section of each of the at least two base frames comprise a plurality of first holes, which facilitates coupling of the at least two base frames over the surface of the AOI, and
wherein the second lower section of each of the at least two clamping frames comprise a plurality of second holes in line with the plurality of first holes of the corresponding base frame, to facilitate coupling of the at least two clamping frames over the surface of the AOI, and the corresponding base frame.

8. The assembly as claimed in claim 7, wherein the assembly comprises one or more fixtures selected from any or a combination of bolt, screw, and clamps, which are adapted to pass through any or a combination of the plurality of first holes and the plurality of second holes, to enable coupling of the at least two base frames over the surface, and coupling of the at least two clamping frames on the corresponding base frames.

9. The assembly as claimed in claim 2, wherein the first middle section of each of the at least two base frames comprise a plurality of third holes, and the second middle section of each of the at least two clamping frames comprise a plurality of fourth holes, wherein the plurality of third holes and the plurality of fourth holes facilitate any or a combination of:
allowing air to flow therethrough to keep bottom of the one or more tiles cool; and
allowing one or more cables to pass therethrough to keep the one or more cables beneath the one or more tiles.

10. The assembly as claimed in claim 1, wherein the at least two base frames, and the at least two clamping frames are made of a material selected from metals, fire-retardant plastics, and fire-retardant materials, and wherein any or a combination of a fire-resistant underlayment and a gypsum board are configured over the surface of the AOI, and the assembly is configured thereover to improve fire resistance capability of the assembly.
